(19) United States
(12) Patent Application Publication
(10) Pub. No.: US 2008/0052690 A1
(43) Pub. Date: Feb. 28, 2008

(54) TESTING SOFTWARE WITH A BUILD ENGINE

(75) Inventor: Anutthara R. Bharadwaj, Hyderabad (IN)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/463,111

(22) Filed: Aug. 8, 2006

(51) Int. Cl. G06F 9/45; G06F 9/44

(52) U.S. Cl. 717/140; 717/136; 717/101

(57) ABSTRACT

Implementations of the present invention include use of a build engine as a test framework driver. Since the build engine can be used with a variety of test frameworks, new test drivers do not necessarily need to be continually created for new software programs. In addition, since the build engine can be configured to use objects, actions and validations can be written in a wide variety of languages, and can be easily reused. Furthermore, use of the build engine as a test framework driver, particularly within the context of XML, can allow complex scenarios and test cases to be readily automated, without the learning curve and compilation requirements typically associated therewith. In particular, a software tester simply visually compose an automated test case from a library of available tasks without having to write a test code or scripts.

### CROSS-REFERENCE TO RELATED APPLICATIONS

N/A

### BACKGROUND

### 1. Background and Relevant Art

As computerized systems have increased in popularity, so have the complexity of the software and hardware employed within such systems. In general, there are a number of reasons that drive software and hardware changes for computerized systems. For example, as hardware capabilities improve, software often needs to change to accommodate new hardware requirements. Similarly, as software becomes more demanding, a similar effect occurs that can push hardware capabilities into new ground. In addition to these reciprocating push forces, end-users continue to demand that software and hardware add convenience by improving automation of certain tasks or features, or by adding automation where none previously existed.

For at least these reasons, software is continually being developed. In some cases, new software programs are written entirely from scratch, while in other cases, some software programs continue through ongoing, incremental updates. Developing software, however, is not a simple matter. In particular, software development typically involves not only the creation of executable code, but also extensive testing techniques that are used to ensure that the executable code works on a variety of platforms, in a variety of settings, and in response to a variety of different tasks. It is not surprising, therefore, that there are large numbers of software programs devoted entirely for testing purposes.

Unfortunately, these various software testing programs tend to be heavily customized, and thus tend to be very use-specific. In particular, there is generally no generic testing “framework” that can be used for all types of programs. Generally, a testing framework includes a layered structure of computer-executable programs, and might further specific programming interfaces that operate in accordance with one or more framework rules. Since there is usually no generic framework in most testing environments, testing a newly written piece of software often involves creation of a new framework that can be used to mimic the actual operating environment. Developing a new framework from scratch, however, can also be quite complex, and can further necessitate development of a new test driver from scratch. Of course, there is no guarantee that the framework and test drivers will work perfectly together once developed, much less as desired when testing the new software. In particular, a software tester may need to develop still further software for the purpose of testing the framework and test driver, and sorting out various bugs between the two.

Once a particular framework and test driver have been appropriately developed, a software tester will still need to test the newly developed software within the framework. Ideally, the software tester tests every possible permutation of use for the software within the framework, and determines if the new software is capable of running as intended. Of course, such an ideal is rarely possible, particularly with large, complex programs that may have hundreds and thousands of possible permutations of use through various user interfaces, and so on. As such, the software tester will often limit testing choices to what the software tester reasonably believes are the most likely ways the new software will be used by an end-user.

In addition, it can often take several testers to test a particular product, especially with larger, more complicated software. Each tester might, for example, have a different component or interface that they are responsible for testing. Each tester might then need to test each different component as it might interface with another component of the new software, to check to see not only if the component works, but to see if it is compatible within the overall program. Once these various rounds of testing have completed, the software testers might then need to integrate each tested component back into the new program, and then test the new program from end to end. One will appreciate that these various levels of testing can involve the creation of still further code, and further automation processes, which often must be rewritten or discarded entirely when testing different, newly created software programs.

Accordingly, there are a number of difficulties associated with testing software that can be addressed.

### BRIEF SUMMARY

Implementations of the present invention provide systems, methods, and computer program products configured to simplify testing procedures using a common testing framework that can be used with a wide range of newly developed software. In particular, implementations of the present invention include the use of a build engine as a test framework driver, which can be used and reused in a wide variety of testing environments. As configured, implementations of the present invention can thus minimize or eliminate the costs of developing a new test driver, allow tests to be easily reusable through objects (written in varying languages), and automate complex bugs involving a complicated series of actions. In addition, implementations of the present invention can minimize a software tester's need to understand specific action or validation test code, avoid software compilation difficulties (e.g., by using XML), and significantly ease debug procedures.

For example, a method from the perspective of a computer system on which is built a project file for testing a preliminary version of software without otherwise creating an end-user version of the software, can involve identifying one or more project details. Generally, the project details include a name of a project and a number of scenarios running in accordance with a project to test software of interest. The method can also involve identifying one or more components to be initiated in order to test the software of interest. In addition, the method can involve identifying one or more scenarios that include a set of one or more actions and at least one validation to be performed for each set of one or more actions.

Furthermore, the method can involve generating the project file. Generally, the project file will include a call to a target for each identified one or more project details, each identified one or more component, to be initiated and each identified scenario. Still further, the method can involve passing one or more instructions to execute the project file at a build engine.

In addition, a method from the perspective of a build engine used as a test driver to test a preliminary version of software without necessarily building an end-user version of the software can involve receiving one or more function calls for a project details target. Generally, the one or more project details target calls will include at least an indication of software to be tested in a project file. The method can also involve receiving one or more function calls for a pre-run target where the one or more pre-run target calls identify one or more set up actions.

In addition, the method can involve receiving one or more function calls for a scenario target. Generally, the one or more scenario target calls will include a request for one or more actions to be executed by the software and one or more validations to be performed after executing the one or more actions. Furthermore, the method can involve receiving one or more function calls for a post-run target, where the one or more post-run target calls identifying one or more finishing actions. Still further, the method can involve, upon executing the one or more function calls, generating a feedback report for the project file.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a conceptual overview diagram in which a project file is created and executed through a build engine in accordance with an implementation of the present invention; and

FIG. 2 illustrates flowcharts of methods of one or more acts for from the perspective of a computer system a build engine for preparing and executing a project file through a build engine in accordance with one or more implementations of the present invention.

### DETAILED DESCRIPTION

Implementations of the present invention extend to systems, methods, and computer program products configured to simplify testing procedures using a common testing framework that can be used with a wide range of newly developed software. In particular, implementations of the present invention include the use of a build engine as a test framework driver, which can be used and reused in a wide variety of testing environments. As configured, implementations of the present invention can thus minimize or eliminate the costs of developing a new test driver, allow tests to be easily reusable through objects (written in varying languages), and automate complex bugs involving a complicated series of actions. In addition, implementations of the present invention can minimize a software tester's need to understand specific action or validation test code, avoid software compilation difficulties (e.g., by using XML), and significantly ease debug procedures.

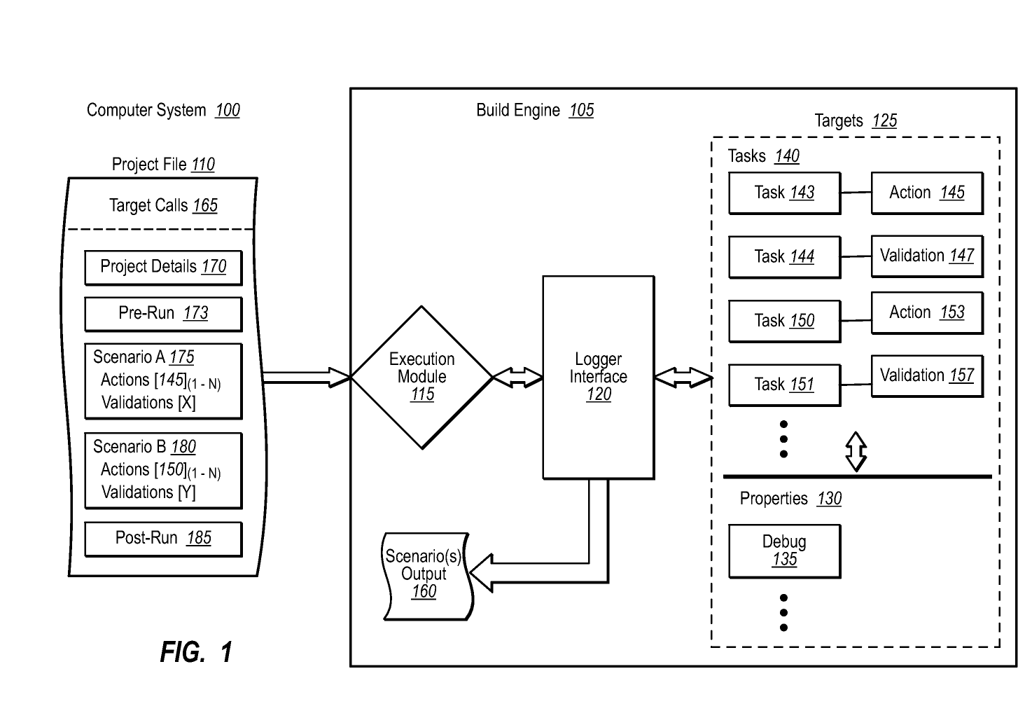

Generally, a software tester will simply need to identify developed software to test (also referred to as “software of interest”), and then create a project file with various components for the test. As will be appreciated more fully herein, a “test” in accordance with implementations of the present invention can be split into two primary parts: one or more “actions,” and one or more corresponding “validations.” With reference to FIG. 1, for example, an action 145 (and/or 153) generally includes the simplest set of one or more operations that can be performed in accordance with the software to be tested. In addition, a validation 147 (and/or 157) generally includes the simplest set of verifications that should be performed after executing the one or more actions. For example, there might be one validation for several sets of actions, or there might be several possible validations that are to be performed after one or more actions.

Actions and validations, in turn, can be represented by one or more “objects” (i.e., object-oriented code), which are part of a subset of a particular “task” (e.g., 143, 144, 150, 151) built within the build engine (e.g., 105). In at least one implementation in the MICROSOFT environment for example, build engine 105 comprises an MSBuild engine, which can be configured to build preliminary software components into end-product software. In addition, “tasks” used within build engine 105 can be encoded in any language. With reference to the MICROSOFT operating environment, for example, tasks might be encoded in any “.NE” language, and further built into Dynamic Language Libraries (also referred to herein as “DLLs,” “.dlls,” or “dlls”). In such a case, project file 110 could be configured to reference these dlls in a particular test case.

In general, an action object (e.g., 145) is essentially a type of task (e.g., 143) that can cause a computer system (e.g., 100) to, for example, open a user interface, execute a command, or the like. By contrast, a validation object (e.g., 147) is also a type of task (e.g., 144). Nevertheless, a validation object can include instructions that cause a computer system (e.g., 100) to execute a verification function, such as causing build engine 105 to validate actions performed in accordance with the software of interest. Thus, in one very basic form, a simple software test can include one action followed by one validation. For example, if testing software in the form of a web page, a possible action could instruct build engine 105 to select a particular hyperlink. The validation, in turn, might instruct build engine 105 to identify if the browser that opened the software of interest also performed the hyperlink redirection instructed through the action object. More complicated tests, therefore, can include a sequence of actions (and multiple combinations thereof) and validations.

In addition, and as used herein, a “scenario” (e.g., 175, 180) generally refers to a set of one or more actions to be performed by build engine 105 combined with a minimal number of verifications needed for that set of actions. In general, the actions and validations within a project file scenario can be mapped to one or more action objects (“A”) and corresponding validation objects (“V”) represented in build engine 105, such as follows for a single scenario.

A₀ A₁A₂ . . . Aₙ V₀

This simple scenario representing a combination of action objects and validation objects, in turn, can be represented as a single target (e.g., 175) in a project file (e.g., 110). In addition, a “test case” refers to a collection of scenarios, where each scenario performs validations on a set of desired features. In particular, a test case can be configured to map to many action objects and validation objects, which can, in turn, be intermingled as a set of several different scenarios, such as follows below.

A₀ A₁ A₂ . . . Aₙ V₀ Aₙ₊₁ Aₙ₊₂ Aₙ₊₃ . . . A₂ₙ V₁ A₂ₙ₊₁ A₂ₙ₊₂ A₂ₙ₊₃ . . . A₃ₙ V₃

In one implementation, action and validation objects can be derived from a basic build engine object. In one implementation of the present invention with respect to the MICROSOFT environment, for example, the most basic build engine object can be referred to as a “base object.” The action and validation objects can thus be derived from the base object to create a project file (e.g., 110).

In general, a base object can be configured to implement one or more sets of properties (e.g., 130), such as debug property 135 shown in FIG. 1. In one implementation, for example, debug property 135 can be used to provide debugging functionality to the action objects (e.g., 145, 153, etc.) and validation objects (e.g., 147, 157, etc.) called by a particular target file. When the debug property 135 is invoked (e.g., set to “true”), the task corresponding to the particular actions and/or validations can be configured to break, and thus allow access to the code for the software of interest.

Accordingly, a software tester that desires to test a particular piece of software or computer-executable instructions can create a project file that is to be executed by a build engine, but also invokes a debug property. Thus, rather than “building” the software of interest, the software tester can use the build engine as a test framework driver that debugs execution of the software of interest. For example, when invoking debug property 135, each action and validation object can be configured to set a break point in one or more portions of their corresponding object code. The following example code, therefore, illustrates one implementation of a base object set to check for debug property 135, and set a breakpoint in the beginning of a testing method.

### EXAMPLE 1

```
using system;
using build.utilities;
namespace common
    {
      public abstract class base.object : task
      {
        protected bool isDebug = false;
        public bool IsDebug
          {
            get {return isDebug;}
            set {isDebug = value;}
          }
      }
    }
```

### In at least in one implementation, the above-identified code instructions can instruct build engine 105 to override execute functions within each task.

In addition to setting breakpoints with debugger property 135, a software tester can also use build engine 105 to identify certain required fields and certain output fields. In particular, the software tester can demark certain fields within a particular object as “required.” In one implementation, this can tell build engine 105 that the marked property should be passed a value when called from project file 110. Similarly, the software tester can also mark any fields with an “output” attribute. In one implementation, any object that contains an output attribute demarcation ensures results in returning output (e.g., 160). In one implementation, the output property can be set to a property defined in the project file that is calling the action object. Example code for an action object and a validation object that includes “required” and “output” attribute demarcations is shown below.

### EXAMPLE 2

Action Object (“AO”)

```
using system.diagnostics;
using build.utilities;
using build.framework;
using system;
using common;
namespace actionobjects
{
  public class createbuildAO : baseobject
  {
    private string buildtypename;
    [required]
    public string buildtypename
    {
      get { return buildtypename; }
      set { buildtypename = value; }
    }
    private string buildplatform;
    [output]
    public string buildplatform
    {
      get { return buildplatform; }
      set { buildplatform = value; }
    }
    public override bool execute( )
    {
      try
      {
        if (isdebug)
        {
          debugger.break( );
        }
        buildplatform = makenewbt(buildtypename);
        return true;
      }
      catch (exception e)
      {
        return false;
      }
    }
    private string makenewbt(string buildtypename)
    {
      string platform;
      return platform;
    }
  }
}
```

### EXAMPLE 3

Validation Object (“VO”)

```
using system.diagnostics;
using build.utilities;
using system;
using build.framework;
using common;
namespace validationobjects
{
  public class checktextintextboxvo : baseobject
  {
    private string texttovalidate;
    [required]
    public string texttovalidate
    {
      get { return texttovalidate; }
      set { texttovalidate = value; }
    }
        public override bool execute( )
    {
      try
      {
        if (isdebug)
        {
          debugger.break( );
        }
        return true;
      }
      catch (exception e)
      {
        return false;
      }
    }
  }
}
```

### In one implementation, a software tester can include the foregoing code of Examples 1 through 3 into dlls, and further include this example code in the project file 110.

In addition to setting debug property 135, as well as any required and output fields, build engine 105 can also expose a logger interface (e.g., 120) that can be used to capture output and pass output to file. In one implementation for example, logger interface 120 can be configured to add event handlers that capture particularly indicated events. Such events indicated to logger interface 120 can include, for example, “Build Started, “Build Ended,” “Target Started,” “Target Ended,” “Task Started,” “Task Ended,” etc. In one implementation, logger interface 120 is further configured so that any program class can access logger interface 120 while the software to be tested is being “built” by build engine 105.

With particular respect to testing software of interest, a software tester can configure logger interface 120 to capture the “Target Started” event in the build engine code, and treat it as the beginning of one or more project file 110 scenarios (e.g., 175, 180). Logger interface 120 can also be configured to identify the “Target Ended” event to identify when a scenario completed executing. Example 4 below provides example code for one implementation of using logger interface 120.

### EXAMPLE 4

Logger Interface

```
using System;
using System.Collections.Generic;
using System.Text;
using Build.Utilities;
using Build.Framework;
namespace LoggerInterface
{
    public override void Initialize(Build.Framework.IEventSource
eventSource)
    {
      eventSource.TargetStarted += new
TargetStartedEventHandler(eventSource_TargetStarted);
      eventSource.ErrorRaised += new
BuildErrorEventHandler(eventSource_ErrorRaised);
      eventSource.TaskStarted += new
TaskStartedEventHandler(eventSource_TaskStarted);
      eventSource.TaskFinished += new
TaskFinishedEventHandler(eventSource_TaskFinished);
    }
    void eventSource_TaskFinished(object sender,
TaskFinishedEventArgs e)
    {
      if (e.Succeeded)
      {
        // Write log entry as “e.TaskName completed successfully.”
      }
      else
      {
        // Write log entry as “e.TaskName failed!”;
      }
    }
    /// <summary>
    /// EventHandler for TaskStarted event
    /// </summary>
    void eventSource_TaskStarted(object sender,
    TaskStartedEventArgs e)
    {
      // Write log entry as “e.TaskName started...”
    }
    /// <summary>
    /// EventHandler for ErrorRaised event
    /// </summary>
    void eventSource_ErrorRaised(object sender,
    BuildErrorEventArgs e)
    {
      // Error occurred during building project file - log it in log file
      // Write log entry as e.Message
    }
    /// <summary>
    /// EventHandler for TargetStarted event
    /// </summary>
    void eventSource_TargetStarted(object sender,
TargetStartedEventArgs e)
    {
      switch (e.TargetName)
      {
        case “Test caseDetails”:
          break;
        case “PreRun”:
          // Write log entry as “Running pre-run sequence”
          break;
        case “PostRun”:
          // Write log entry as “Running post-run clean up sequence”
          break;
        default:
          // Write log entry as “Initializing scenario e.TargetName”
          break;
      }
    }
  }
}
```

Having identified actions and validations, debug property, any required and output attributes, and having configured a logger interface, the software developer can then create a project file for a test case that calls these elements. For example, FIG. 1 illustrates project file 110, which includes at least one implementation of a basic test case. As shown, project 100 includes a target call 170 for project details, a target call 173 to initiate set up components (i.e., “pre-run”), a target call 175 (and/or 180) for one or more scenarios, and/or a target call 185 to close previously initiated components. For example, target call 170, which can be configured to be called at the beginning of execution, can contain tasks that instruct build engine 105 to log or write test case details such as test run name, number of scenarios running, and so forth. Build engine can thus write this information into an output file for the test (e.g., output 160).

In addition, target call 173 can include an aggregation of action objects configured to prepare the appropriate operating environment for the software of interest. For example, the software tester might want to test a user interface. This particular software of interest might necessitate testing a menu item in a context menu, which is further found in a tool window inside an application. As such, target call 173 might include one or more action objects that, when executed, open the relevant application, open the tool window, and then generate the context menu.

FIG. 1 also shows that project file 110 can include a sequence of target calls for one or more scenarios (e.g., 175, 180). As previously mentioned, each target call for a scenario can further include one or more action objects followed by a single validation object. For example, FIG. 1 shows that target call 175 for “Scenario A” includes an indication of “Actions [145]₍₁₋ₙ₎” and one or more “Validations [X].” Similarly, FIG. 1 shows that target call 180 for “Scenario B” includes an indication of “Actions[150]₍₁₋ₙ₎” and one or more “Validations[Y].”

Furthermore, FIG. 1 shows that project file 110 can include a target call 185 (i.e., “post-run”), which can include instructions to close previously initiated components (i.e., those initiated in “pre-run” target call 173). In one implementation, target call 185 can reference an aggregation of action objects that are configured clean up after build engine executes a particular a test case. With respect to the previously described user interface, for example, target call 185 can include one or more tasks instructing build engine 105 to close the tool window, close the application, and/or or even close a message box that popped up due to errors or exceptions. The following illustrates an Extensible Markup Language (“XML”) version of an example project file.

### EXAMPLE 5

Test Project File (e.g., 110)

```
<Project DefaultTargets =“Check Build Type Name;Check Build Type
Platform” xmlns=“http://schemas.com/developer/build/2003”>
  <!-- Using tags for all tasks-->
  <UsingTask TaskName=“OpenBuildWizardAO”
AssemblyFile=“CommonAO.dll”/>
  <UsingTask TaskName=“LogTest caseDetailsAO”
AssemblyFile=“CommonAO.dll”/>
  <UsingTask TaskName=“CheckBuildText”
AssemblyFile=“CommonVO.dll”/>
  <UsingTask TaskName=“OpenAppAO”
  AssemblyFile=“CommonAO.dll”/>
  <UsingTask TaskName=“CloseAppAO”
  AssemblyFile=“CommonAO.dll”/>
  <UsingTask TaskName=“KillRandomWindowsAO”
AssemblyFile=“CommonAO.dll”/>
  <UsingTask TaskName=“CreateBuildType”
AssemblyFile=“CommonAO.dll”/>
  <!-- Define properties that will be used-->
  <PropertyGroup>
    <PlatformGenerated></PlatformGenerated>
  </PropertyGroup>
  <!-- Target to log all test case details-->
  <Target Name=“TestcaseDetails”>
    <LogTestcaseDetailsAO TestcaseID=“$(TestcaseID)” Test
caseDescription=“$(TestcaseDescription)” />
  </Target>
<!-- Target to prepare the test environment to run test-->
  <Target Name=“PreRun”>
    <OpenAppAO AppName=“TeamBuild”/>
  </Target>
<!-- Scenario 1-->
  <Target Name=“Check Build Type Name” >
    <OpenWizardAO />
    <CreateBuildType Name=“BuildType1”>
      <!-- Save the output of the task in a property
      defined in this proj file-->
      <Output TaskParameter =“BuildPlatform” PropertyName =
“PlatformGenerated”></Output>
    </CreateBuildType>
    <CheckBuildTypeName ExpectedName=“BuildType1”/>
  </Target>
<!-- Scenario 2-->
  <Target Name=“Check Build Type Platform” >
    <OpenWizardAO />
    <CheckBuildTypePlatform
    ExpectedPlatform=$(PlatformGenerated)/>
  </Target>
  <!-- Target to clean up after test execution -->
  <Target Name=“PostRun” >
    <CloseAppAO AppName=“TeamBuild”/>
    <KillRandomWindows />
  </Target>
</Project>
```

The software tester can then test the software of interest by “building” the project file through build engine 105. For example, the software tester could call the project file through a command line reference, such as follows.

C:>buildengine testproject110.proj

Build engine 105 can then execute project file 110 through execution module 115. For example, build engine 105 can receive project file 110 from local or remote storage media, and pass project file through execution module 115. The instructions in project file 110 can then cause execution module to call each action and/or validation, as appropriate, to thereby test the software indicated in target call 170. Logger interface 120 can then intercept the output where indicated in the relevant code, and generate a return file for the test case. In particular, logger interface 120, can continually log events in the background whenever events are generated.

One will appreciate, therefore, that the above-described components and modules can be used for a wide range of functions when using a build engine as a test framework driver. In particular, implementations of the present invention can further include components for finding a wide range of new bugs that are difficult to find. In one implementation, for example, a software tester can aggregate tasks in a project file (e.g., 110). The software tester can then subject the actions to any number of automated randomizations (not shown) to generate randomized project files (not shown). In one implementation, the software tester can also subject such randomization to a set one or more rules, such that the randomized action and validation objects are nevertheless called by build engine 105 in valid sequences.

For example, a software tester can feed a list of available action and validation objects along with a set of constraints to a grammar generating engine (not shown). This set of constraints can generally include a list of natural language limitations that are configured to confine the number of valid sequences of action and validation objects. As such, the grammar generating engine can produce one or more outputs that describes all valid sequences of the action and validation objects. The software tester can then feed the one or more outputs into one or more random project file generators, which takes the list of objects along with the grammar, and generates random valid sequences of scenarios in every test case of a particular project file generated. Creating project files in this manner can significantly increase component coverage.

In addition, one will appreciate from the drawings and corresponding text herein that build engine 105 can be used to simplify user interface testing. In one implementation, for example, a software tester can convert all actions on a given user interface into objects. For instance, the software tester can convert the actions of clicking on a button, bringing a drop down menu into focus, and entering a value in a text box as corresponding one or more action objects of a particular one or more tasks. In particular, these tasks can be written using the object model of the user interface system. The corresponding one or more validation objects can then be configured to validate the end state of the system after running the action objects. Accordingly, building test cases around these objects can be a matter of simply arranging the requisite action and validation objects in targets in project file. This allows the tester to build a wide range of test cases for user interfaces without necessarily having to write new code for each test case.

In addition, implementations of the present invention can be further used to improve the efficiency of testing interfacing components. In particular, a software tester will generally need only to include a test case project file from each component into a single test case project file using the “Include” functionality provided in most build engines to join two scripts. The MSBuild engine, for example, can include a tag that simply in-lines the project file with the new project file. Where there are no pre-existing test cases with the appropriate input values, the software tester need only script one or more corresponding project files that calling preexisting tasks with the required input values. The software tester can thus still avoid writing complicated compilable code for a test case since even test cases can be reusable since the objects for the test case are reusable.

In addition, one will appreciate that implementations of the present invention can further be used to automate complicated scenarios. In particular, a software tester can simply script a project file that calls the tasks in each target sequenced to match the sequence of test cases. The software tester can then execute the scripted project file without writing new, compiled code (and performing the requisite compilation). Such automation can be further used for a variety of types of tests. For example, implementations of the present invention can further be used for stress and performance testing.

In one implementation, for example, a software tester can include a given test case project file many times in a single project file to simulate varying loads and execution of these project files. The software tester can further call build engine 105 multiple times on the sequence of test case project files over a batch file, or programmatically. In either case, the software tester can automate stress and performance testing without necessarily being required to create new code. In particular, stress and load testing can be as simple as giving new values to input properties.

Accordingly, FIG. 1 and the corresponding text provide a number of components and mechanisms for testing software with a build engine. In particular, a build engine can be used outside of its customary purpose(s) by using an easily scripted project file that calls particular properties that can be defined within (e.g., debug property 135), sets required and output attributes in a simple XML file, and calls a logger interface. These elements and components thus allow the build engine to override customary build functions by executing particular action and validation objects, and generating corresponding scenario output files that indicate the success or errors of any given test.

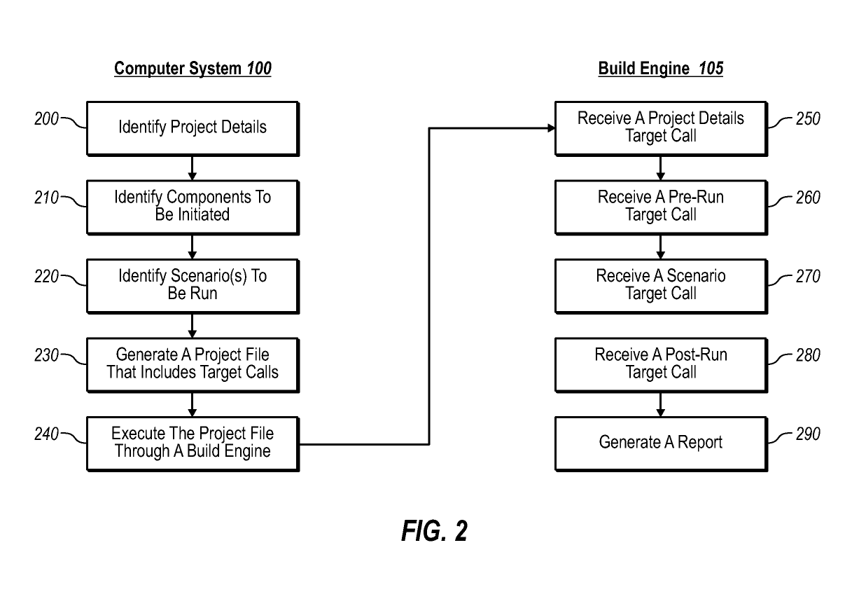

In addition to the foregoing, implementations of the present invention can also be described in terms of methods comprising one more acts of accomplishing a particular result. For example, FIG. 2 illustrates methods from the generic perspective of computer system 100 (at which project file 110 might be generated) and build engine 105 for testing a preliminary version of software without necessarily building a final (end product) version of the software. The acts of FIG. 2 are described below with reference to the schematic diagram of FIG. 1.

For example, FIG. 2 shows that a method of testing a preliminary version of software through a build engine without otherwise creating an end-user version of the software comprises an act 200 of identifying project details. Act 200 includes identifying one or more project details, the project details including a name of a project and a number of scenarios running in accordance with a project to test software. For example, computer system 100 encodes various details about the project to be tested into one or more target calls 165, which includes a target call 170 for project details. Target call 170 is, in turn, generally configured to inform build engine 105 of these details, which can ultimately be placed in output report 160.

In addition, FIG. 2 shows that the method from the perspective of computer system 100 comprises an act 210 of identifying components to be initiated. Act 210 includes identifying one or more components to be initiated in order to test the software of interest. For example, computer system 100 includes (via instruction from a software tester, not shown) one or more action objects that instruct build engine 105 to open one or more interfaces, in the case where the software of interest is directed to a particular application interface.

FIG. 2 also shows that the method from the perspective of computer system 100 comprises an act 220 of identifying one or more scenarios to run. Act 220 includes identifying one or more scenarios that include a set of one or more actions and at least one validation to be performed for each set of one or more action. For example, computer system 100 aggregates one or more action objects together with the appropriate validation objects into one or more scenario target calls 175, 180. In addition, FIG. 2 shows that the method from the perspective of computer system 100 comprises an act 230 of generating a project file that includes the target calls. Act 280 includes generating the project file that includes a call to a target for each identified one or more project details, each identified one or more component to be initiated, and each identified scenario. For example, computer system 100 finalizes and creates project file 110, which includes all appropriate “required,” “output,” “debug,” and “logger” requests and/or function calls.

Furthermore, FIG. 2 shows that the method from the perspective of computer system 100 comprises an act 240 of executing the project file through a build engine. Act 240 includes passing one or more instructions to execute the project file at a build engine. For example, computer system 100, upon appropriate instruction through a command line prompt, passes one or more instructions to build engine 105. Generally, the instructions indicate the name of the project file, a file path (local or network) to the project file, and a request to execute the project file. Build engine 105 can then receive and execute the project file through a corresponding execution module.

Accordingly, FIG. 2 also shows that a method from the perspective of build engine 105 of testing a preliminary version of software without necessarily building an end-user version of the software comprises an act 250 of receiving a project details target call. Act 250 includes receiving one or more function calls for a project details target, the one or more project details target calls including at least an indication of software to be tested in a project file. For example, build engine 105 receives project file 110, and identifies and executes target call 170 through execution module 115. Target call 170 indicates various one or more details about the software to be tested, such as the name of the software of interest, date and time the test was run, and so forth.

In addition, FIG. 2 shows that the method from the perspective of build engine 105 comprises an act 260 of receiving a pre-run target call. Act 260 includes receiving one or more function calls for a pre-run target, the one or more pre-run target calls identifying one or more set up actions. For example, build engine 105 identifies and executes target call 173, which includes an aggregation of one or more action objects configured to set up an operating environment. If testing a web page, for example, the received and executed target call might include one or more action objects that open a web browser, and then open the software within the web browser.

FIG. 2 also shows that the method from the perspective of build engine 105 comprises an act 270 of receiving one or more scenario target calls. Act 270 includes receiving one or more function calls for a scenario target, the one or more scenario target calls including a request for one or more actions to be executed by the software and one or more validations to be performed after executing the one or more actions. For example, build engine 105 identifies and executes any of target calls 175, 180 through execution module 115. Targets 175, 180 identify a set of one or more action objects and corresponding one or more validation objects to be executed for the software of interest.

In addition, FIG. 2 shows that the method from the perspective of build engine 105 comprises an act 280 of receiving one or more post-run target calls. Act 280 includes receiving one or more function calls for a post-run target, the one or more post-run target calls identifying one or more finishing actions. With reference to the web page testing scenario identified for act 260, for example, the one or more post-run target calls might close the browser used to open the software of interest. Furthermore, FIG. 2 shows that the method from the perspective of build engine 105 comprises an act 290 of generating a report. Act 290 includes, upon executing the one or more function calls, generating a feedback report for the project file. For example, logger interface 120 intercepts output as appropriate for each action and validation object indicated in project file 110, and further sends output for the same into scenario output report 160.

Accordingly, FIGS. 1 and 2, and the corresponding description, provide a number of systems, components, and methods for readily testing software of interest through a build engine. In particular, the foregoing components can be set up in many respects as though they were being prepared to be “built” into an end product. Nevertheless, when the software tester provides a build engine with the appropriate attributes and fields, these components are simply tested through a build engine, which is used as a test framework driver to generate corresponding output. As such, implementations of the present invention provide a number of ways in which a build engine can be manipulated to test rather than necessarily build a particular piece of software code. This can eliminate many of the concerns and efforts otherwise required when building a test framework and corresponding test drivers.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. At a build engine in a computerized environment, the build engine comprising one or more targets otherwise configured to build a software program when executed through the build engine, a method of testing a preliminary version of software without necessarily building an end-user version of the software, comprising the acts of:
receiving one or more function calls for a project details target, the one or more project details target calls including at least an indication of software to be tested in a project file;
receiving one or more function calls for a pre-run target, the one or more pre-run target calls identifying one or more set up actions;
receiving one or more function calls for a scenario target, the one or more scenario target calls including a request for one or more actions to be executed by the software and one or more validations to be performed after executing the one or more actions;
receiving one or more function calls for a post-run target, the one or more post-run target calls identifying one or more finishing actions; and
upon executing the one or more function calls, generating a feedback report for the project file.

2. The method as recited in claim 1, wherein the scenario target calls include an indication of a plurality of actions and a plurality of validations of the plurality of actions to be performed by the build engine.

3. The method as recited in claim 2, wherein the plurality of actions have been randomly mixed prior to being received through the scenario target calls.

4. The method as recited in claim 3, wherein the plurality of actions have been automatically randomized prior to being received through the scenario target calls.

5. The method as recited in claim 4, wherein the plurality of actions have further been subject to one or more constraints that limit the randomized actions to one or more sequences of the actions that are possible.

6. The method as recited in claim 1, further comprising an act of receiving one or more function calls for a different scenario target, the different scenario target calls including a request for one or more different actions to be executed by the software and one or more different validations to be performed after executing the one or more different actions.

7. The method as recited in claim 1, wherein the one or more project details target calls further include one or more of a project name, a date and time, and a number of scenarios to be executed.

8. The method as recited in claim 1, further comprising identifying a request for a debug function, the debug function being configured to set one or more breakpoints of execution in the project file.

9. The method as recited in claim 1, wherein the one or more set up actions include one or more requests to execute one or more environmental components that are to be used by the software during execution.

10. The method as recited in claim 9, wherein the one or more post-run target calls include one or more requests to close the one or more environmental components executed by the pre-run target calls.

11. The method as recited in claim 1, wherein project file is an interchange file format, such as an XML format file.

12. The method as recited in claim 1, further comprising an act of identifying one or more target starting points and one or more target ending points through a logger interface.

13. In a computerized environment comprising a build engine installed therein and a testing computer having access to the build engine, a method of testing a preliminary version of software through the testing computer system and the build engine without otherwise creating an end-user version of the software, comprising the acts of:
identifying one or more project details, the project details including a name of a project and a number of scenarios running in accordance with a project to test software of interest;
identifying one or more components to be initiated in order to test the software of interest;
identifying one or more scenarios that include a set of one or more actions and at least one validation to be performed for each set of one or more actions;
generating a project file that includes a call to a target for each identified one or more project details, each identified one or more components to be initiated, and each identified scenario; and
passing one or more instructions to execute the project file at a build engine.

14. The method as recited in claim 13, further comprising the acts of:
identifying a plurality of actions to be performed within the identified one or more scenarios; and
randomizing the plurality of actions.

15. The method as recited in claim 14, further comprising an act of constraining the randomizing of the plurality of actions to one or more rules.

16. The method as recited in claim 13, further comprising including within the project file one or more post-run target calls configured to close each of the one or more components after the one or more scenarios have been executed.

17. The method as recited in claim 13, further comprising a step for executing the project file through the build engine to simulate a larger than expected amount of load on a computer system.

18. The method as recited in claim 17, wherein the step for executing the project file further comprises an act of submitting multiple copies of the project file to the build engine, such that the build engine executes on the multiple copies of the project file.

19. The method as recited in claim 17, wherein the step for executing the project file further comprises an act of instructing the build engine to execute the project file a plurality of times.

20. In a computerized environment that includes a build engine having one or more targets otherwise configured to build a software program when executed through the build engine, a computer program product having computer-executable code stored thereon that, when executed, cause one or more processors in a computer system to perform a method of testing a preliminary version of software without necessarily building an end-user version of the software, comprising the acts of:
receiving one or more function calls for a project details target, the one or more project details target calls including at least an indication of software to be tested in a project file;
receiving one or more function calls for a pre-run target, the one or more pre-run target calls identifying one or more set up actions;
receiving one or more function calls for a scenario target, the one or more scenario target calls including a request for one or more actions to be executed by the software and one or more validations to be performed after executing the one or more actions;
receiving one or more function calls for a post-run target, the one or more post-run target calls identifying one or more finishing actions; and
upon executing the one or more function calls, generating a feedback report for the project file.
